(19) United States
(12) Patent Application Publication
(10) Pub. No.: US 2022/0068509 A1
(43) Pub. Date: Mar. 3, 2022

(54) ELECTRON AND ION CYCLOTRON RESONANCE ENABLED FUSION REACTORS

(71) Applicant: Alpha Ring International Ltd., Monterey, CA (US)

(72) Inventors: Alfred Y. Wong, Los Angeles, CA (US); Allan Xi Chen, Daly City, CA (US)

(21) Appl. No.: 17/054,139

(22) PCT Filed: May 9, 2019
(86) PCT No.: PCT/US19/31595

§ 371 Date: May 26, 2021

Related U.S. Application Data
(60) Provisional application No. 62/669,229, filed on May 9, 2018.

(51) Int. Cl. G21B 1/05; G21B 1/21; H01F 6/06

(52) U.S. Cl. CPC G21B 1/05; H01F 6/06; G21B 1/21

(57) ABSTRACT

Fusion reactor designs and techniques are provided in which an electron cyclotron resonance (ECR) system is coupled to a cylindrical reactor to generate ions within the reactor to form a weakly ionized plasma. An ion cyclotron resonance (ICR) system, also coupled to the cylindrical reactor, is further utilized to accelerate the ions radially in the cylindrical reactor with increasing circular trajectory. The ions are contained within a uniform magnetic field provided by a superconducting magnet coupled to the cylindrical reactor. As the ions are accelerated they also drive neutral particles within the reactor to the same energy level through the mechanism of ion-neutral coupling. Collisions of plasma particles with a target also create macroparticles to form a “dusty” plasma, in which the macroparticles contain multiple charges and masses which can sustain fusion reactions.

### CROSS-REFERENCE TO RELATED APPLICATION AND CLAIM OF PRIORITY

This application claims priority under 35 U.S.C. 119(e) of copending provisional U.S. Application Ser. No. 62/669,229 filed May 9, 2018, the disclosure of which is incorporated herein by reference in its entirety.

### TECHNICAL FIELD

This invention is related to fusion reaction systems, especially using electron cyclotron resonance and ion cyclotron resonance in conjunction with electron screening to enable more efficient fusion reactions.

### BACKGROUND

Creating commercially viable fusion has been challenging because of a high energy input required to “ignite” reactants in a fusion reactor. This high energy input is necessary to overcome the electrostatic repulsion (or Coulomb barrier) between two positively charged reactant nuclei. Conventionally, the energy input into reactants is much larger than any energy created by the fusion reaction, for example a temperature at millions of degrees is required in a traditional magnetic or inertial confinement fusion reactor, resulting in a fusion energy gain factor Q less than 1, where Q=E_{fusion}/Eᵢₙ, where E_{fusion} is the total energy released by fusion reactions, and Eᵢₙ is the energy used to create the reactions.

As discussed in U.S. application Ser. No. 15/973,306 entitled “Reducing the Coulombic Barrier to Interacting Reactants,” filed on May 7, 2018 (hereinafter the “the '306 application”), the entirety of which is incorporated by reference herein, conventional fusion reactors and methods require temperatures in excess of 150,000,000 degrees Celsius to achieve a sustainable fusion reaction with Q>1. Such high temperature and energy requirements have made conventional fusion techniques commercially unviable. Although attempts to achieve fusion at lower temperatures have been extensively researched, such attempts have failed to achieve commercially viable fusion processes and reactors, for the reasons discussed in the '306 application.

### SUMMARY OF INVENTION

The exemplary embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the invention.

This disclosure concerns various aspects of reactor designs and techniques in which an electron cyclotron resonance (ECR) system is coupled to a cylindrical reactor to generate ions within the reactor. An ion cyclotron resonance (ICR) system, also coupled to the cylindrical reactor, is further utilized to accelerate the ions radially in the cylindrical reactor with increasing circular trajectory. In some embodiments, the ions are contained within a uniform magnetic field provided by a superconducting magnet coupled to the cylindrical reactor. As the ions are accelerated, they also drive neutral particles within the reactor to the same energy level through the mechanism of ion-neutral coupling, as discussed in further detail below.

This invention allows a fusion reaction to occur at temperatures much lower (e.g., 1500 to 5000 degrees Celsius) than the typical temperatures required in conventional fusion reactors, enabling a construction of commercially viable fusion-based power sources. Additionally, this method allows for effective scaling of the power generation, from small scale power generation for a home or building to utility scale power generation for city grids, for example.

While ECR and ICR systems are known in the art, the combination of these techniques, along with methods for lowering the Coulomb barrier described herein, have not been previously used to initiate and sustain a fusion reaction. The lowering of the Coulomb barrier enables fusion ignition at lower temperatures; the lower temperatures enables the use of ECR and ICR to drive the reactants to ignition. The lower ignition temperature further enables a net positive energy production and makes the fusion reaction commercially viable. Additionally, in some embodiments, a fusion reactor in this design does not require special engineering processes (e.g., magnetic confinement) to contain and maintain high temperature reactants. Additionally, confinement of the fusion reactants in a plasma form in the present disclosure can be achieved with ordinary and easily sourced non-exotic materials (e.g., stainless steel, titanium, etc.)

In accordance with some embodiments, ICR and ECR techniques within a uniform magnetic field are combined to energize the fusion reactants while a dense collection of free electrons (e.g., 10²⁴ to 10²⁷ electrons/m³) are used to lower the effective electrostatic repulsion between fusion reactants (i.e., lowering the coulombic barrier using electron screening). The principles of electron screening to lower the coulombic barrier are described in further detail in the '306 application. The combination of these techniques enables a fusion reaction to occur at much lower temperatures, on the order of thousands of degrees Celsius, as opposed to millions of degrees Celsius, as typically required by conventional fusion techniques. By lowering the temperature/energy level required for the fusion reaction, a net positive energy can be extracted from the fusion reaction. Additionally, due to the lower temperature requirements and the attainment of resonance, the reactor to contain and maintain the fusion reaction can be greatly simplified (e.g., no need for magnetic confinement) and can be made using relatively inexpensive materials (e.g., stainless steel or titanium), thus enabling a fusion reactor system and method that is commercially viable.

### BRIEF DESCRIPTION OF THE DRAWINGS

FIG. 1 is a cross-sectional view of an exemplary fusion reactor system according to one embodiment of the invention;

FIGS. 2A and 2B are plots of trajectory, and ion energy of H+ respectively, as a function of time at 13.56 MHz ICR frequency, 30 resonant cycles, B=0.889 Tesla, and E=10⁴ V/m;

FIGS. 3A and 3B are plots of trajectory and ion energy of H+ as a function of time at 305 MHz ICR frequency, 100 resonant cycles, B=20 Tesla, and E=10⁶ V/m;

FIG. 4 is a diagram of spectroscopic measurements showing that ions and neutrals rotate and expand radially in the same manner;

FIG. 5 is a graph showing final velocity squared as a function of applied voltage according to one embodiment of the invention showing that as many as 8.7×10⁶ neutrals can be accelerated with each ion;

FIG. 6 is a histogram of a distribution of H and H+ counts at different eV levels in a plasma created by an ICR/ECR system according to the invention;

FIGS. 7A-7C illustrate various side views of an exemplary ECR/ICR enabled cylindrical fusion reactor with a cryomagnetic coil according to an embodiment of the invention;

FIG. 8 is a schematic diagram of an ECR/ICR fusion reactor system according to an exemplary embodiment of the invention;

FIG. 9 is a flow diagram of a process for initiating a fusion reaction in accordance with the invention;

FIG. 10 shows a fusion cross section for hydrogen ion-boron as a function of reactant energy for various screening energies;

FIG. 11 is a cross-sectional view of a fusion reactor with LaB6 on the inner surface of the reactor wall to provide screening and lower the coulomb barrier between fusion reactant;

FIG. 12 is a cross-sectional view of an ECR/ICR enabled cylindrical fusion reactor with superconducting magnet coils using dusty plasma for fusion reactions

FIG. 13 is a cross-sectional view of an ECR/ICR enabled cylindrical fusion reactor with 8 cylindrical reaction vessels enclosed by a superconducting magnet coil to increase the number of reaction sites.

FIGS. 14A-14C are photographic depictions showing the creation of macroparticles by the ECR/ICR system, which result in the creation of a “dusty plasma.”

FIG. 15 is a photographic depiction of marks impressed on the inner wall of the reactor by the cyclotron orbit of dusty plasma macroparticles.

FIG. 16 is a photographic depiction of fusion products left in the reactor chamber when the dusty plasma macroparticles collide with the chamber wall.

FIG. 17 is a schematic diagram of an experimental set-up reactor according to the invention for observing the generation of a plasma cone.

FIG. 18 is a photographic depiction of a plasma cone produced by the set-up of FIG. 17.

FIG. 19 is a photographic depiction of an ion beam—steel target interaction in the presence of an ICR plasma.

FIG. 20 is a graph of fusion neutron counts produced in the presence and absence of an ICR plasma.

FIG. 21 is a graph of percentage increase in fusion neutron count due to the presence of an ICR plasma.

### DETAILED DESCRIPTION OF EXEMPLARY EMBODIMENTS

Aspects of the present disclosure are best understood from the following detailed description when read with the accompanying figures. It is noted that various features are not necessarily drawn to scale. In fact, the dimensions and geometries of the various features may be arbitrarily increased or reduced in the figures for clarity of discussion.

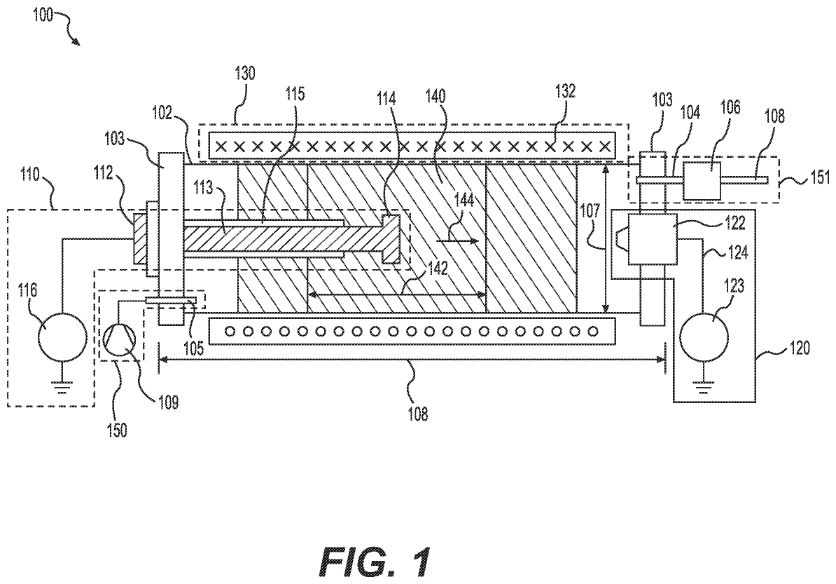

FIG. 1 illustrates a cross-sectional view of an exemplary fusion reactor system 100 comprising a cylindrical reactor chamber 102, an ICR system 110 coupled to one end of the cylindrical reactor and an ECR system 120 coupled to an opposite end of the cylindrical reactor. The fusion reactor system also comprises a superconducting magnet 130 having a superconducting cryogenic magnetic coil 132 surrounding the cylindrical reactor chamber 102 providing a magnetic field 144 along the axis of the reactor in a direction from left to right. The system includes a vacuum control unit 150 and a gas control unit 151. Vacuum control unit 150 includes a vacuum pump 109 coupled to the reactor chamber via a vacuum port 105. The gas control unit 151 includes a Mass Flow Controller (MFC) 106. The ECR/ICR units, vacuum control unit and gas control unit are coupled to the reactor chamber 102 through steel plate isolation windows 103.

As shown in FIG. 1, in some embodiments, the cylindrical reactor has a length 108 of approximately 250 centimeters (cm) and an internal bore diameter 107 of approximately 35.6 cm. In some embodiments, a uniform magnetic (B) field 144 can be created within the reactor such that the length of the uniform B-field 142 is approximately 160 cm. Such uniform magnetic field can be created by applying current in a solenoid (i.e., a coil of wire) of the superconducting magnet coil.

In accordance with various embodiments, the ECR system 120 includes a microwave source generator 123 that outputs microwaves into the chamber of the reactor through a set of waveguides 124 and a microwave antenna 122 to generate a weakly-ionized plasma 140 near the center of the cylindrical reactor. As used herein, a “weakly-ionized plasma” refers to a plasma having a concentration of ions of 5% ionization or less. In some embodiments, a neutral gas comprising one of the following: e.g., hydrogen, deuterium, tritium, boron trifluoride, borane, etc. is injected into the reactor by a mass flow controller (MFC) 106 through a gas pump port 104. The MFC 106 may also have a gas purge line 108. In some embodiments, a Hydrogen (H₂) gas is injected into the reactor. The microwaves resonate and excite electrons within the reactor resulting in collisions with the H atoms thereby producing a weakly-ionized plasma comprising H ions (H⁺). Such ionization processes are known in the art and need not be further described herein.

In some embodiments, a hundred watts or less of power from the electromagnetic wave of the ECR 120 can drive electrons to energy levels in the kilo-electron Volt (keV) range. In some embodiments, the electromagnetic wave for ECR excitation is a microwave with a frequency in the range of 2 Giga-Hertz (GHz) to 560 GHz. The ECR source and the magnetic field created by the superconducting magnet excites the electrons of the reactants in the fusion reactor, increasing their radius of gyration about the magnetic field lines. In certain embodiments, the ECR source can be a high power LDMOS (Laterally Diffused Metal Oxide Semiconductor Field Effect Transistor) or GaN (Gallium Nitride)-based solid-state amplifier. In some other embodiments, the electromagnetic wave for ECR excitation can be generated by a magnetron, a klystron, or a gyrotron with an appropriate matching element such as a one, two or three stub tuner or a coaxial tuner. In some embodiments, the ECR source comprises a microwave generator and waveguides. In some embodiments, the microwave generator is SAIREM GMS 200 Watt (W) with a frequency 2.4-2.5 GHz and 200 W maximum power or SAIREM MEK1017 also with frequency tunable between 2.4 to 2.5 GHz and maximum power of 450 W, or a combination of multiple such generators using one or several Wilkinson power combiner(s).

The cyclotron resonant frequency of ions or electrons is given by:

w=qB/m (eq 1)

where q is absolute value of the charge of the electrons or ion, B is magnetic field strength in Tesla, and m is the mass of the electron or ion. For some embodiments, neutral hydrogen is the ionized species. Since q is equal for an electron and a hydrogen-1 ion but m is several orders of magnitude greater for an H⁺ ion, at a given value of magnetic field, H⁺ ion has a cyclotron frequency that is several orders of magnitude less than the ECR frequency. The electrons are accelerated to energies of several eV to tens of eVs by the ECR wave. As they collide with the sparse density of gas molecules in the middle, the neutrals can be efficiently ionized by these electrons to create a weakly-ionized plasma. Only about 20 eV is required to ionize one neutral hydrogen atom.

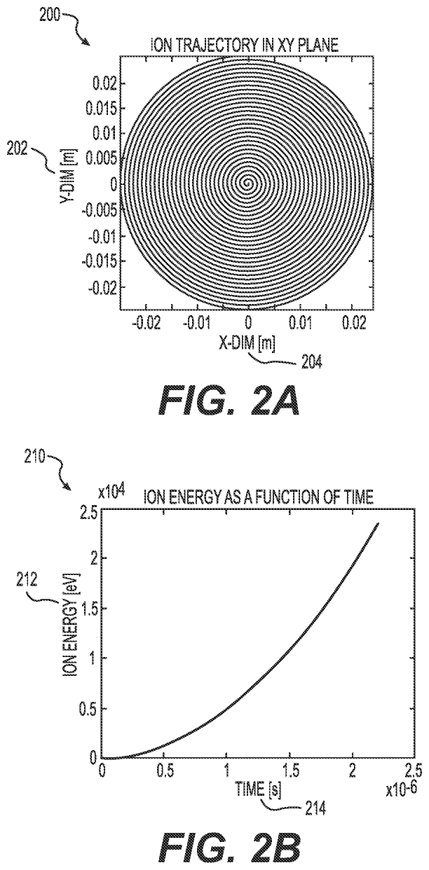

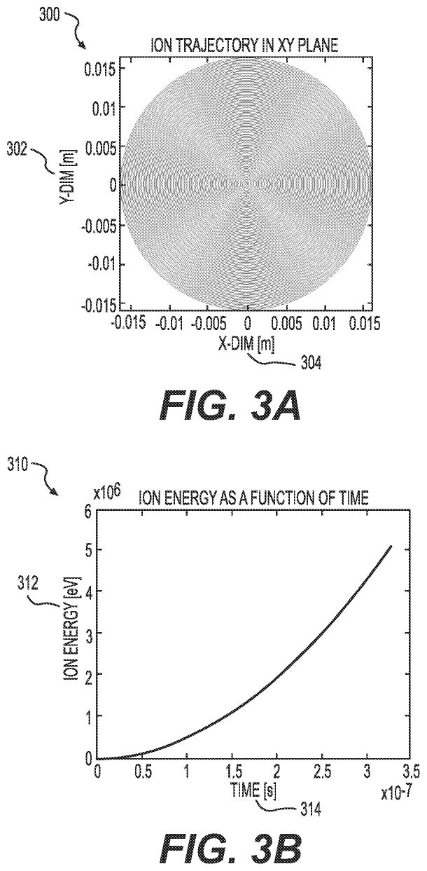

Within this reactor containing uniform, weakly ionized plasma, a lower frequency electromagnetic wave from an ICR source generator 116 can be simultaneously injected to accelerate the ions at the center of the reactor azimuthally at the ion cyclotron frequency, through ICR coaxial launcher 113 and antenna 114 via waveguides 112. ICR generator 116 can be an RF generator having frequency range of 1 MHz to 350 MHz. In some embodiments the coaxial launcher 113 is isolated from at least part of the reactor chamber by isolation shield 115. ICR accelerates the ions to high velocities when reaching the inner surface of the reactor wall for the fusion reaction, as shown in FIGS. 2 and 3. FIG. 2A is a plot 200 of ion trajectory in the xy plane 202-204, for the ion energies shown in FIG. 2B, which is a plot 210 of ion energy of H⁺ (212) as a function of time (214) at 13.56 MHz ICR frequency, 30 resonant cycles, B=0.889 Tesla, and E=10⁴ V/m. FIG. 3A is a plot 300 of ion trajectory in the xy plane (302-304) for ion energy shown in FIG. 3B, which is a plot 310 of ion energy of H+ (312) as a function of time (314) at 305 MHz ICR frequency, 100 resonant cycles, B=20 Tesla, and E=10⁶ V/m. FIGS. 2 and 3 show trajectory and velocity plot of hydrogen ions under different ICR frequency, magnetic field and electric field.

In some embodiments, this ICR source is used to create amplitude modulation, phase modulation, or both. The second frequency is selected such that it matches the ion cyclotron frequency of hydrogen ions (H⁺), deuteron (D⁺), or helium-3 ion (³He²⁺) depending on the reaction of interest, present in the weakly ionized region at the center of the fusion reactor where rotation is being induced. The ICR source with frequency in a range of 1 MHz to 350 MHz comprises a radio frequency generator and matching network which is further connected to a coaxial launcher 113. In some embodiments, the coaxial launcher is located at the center of the fusion reactor, which acts as an antenna. As the ions in the weakly ionized plasma 140 rotate outward, they will also cause simultaneous rotation of the neutral molecules near the edge of the reactor through a mechanism of ion-neutral coupling. In some embodiments, a plasma column will have a radius defined by the smaller of the Larmor radius or the radius of the reactor. In some embodiments, the plasma column which is the region with weakly ionized plasma produced by the ECR in the center is the source of ions. In some embodiments, the ICR source is driven by Advanced Energy Cesar 1350 at a frequency of 13.56 MHz and 3 kilo-Watt (kW) maximum power with a similar power-rated matching network. In a different embodiment, the ICR wave can be produced by a SAIREM GHP 1000 KE 27.12 MHz RF generator with similar power-rated matching network.

The trajectory and velocity of ions caused by the ICR can be determined by the differential equations below:

Eₓ=E.*cos(2.*pi.*f.*t) (eq 2)

d\dot{x}/dt=q./m.*(Ex+B.*\dot{y}) (eq 3)

Ey=−E.*sin(2.*pi.*f.*t) (eq 4)

d\dot{y}/dt=q./m.*(Ey−B.*\dot{x}) (eq 5)

wherein E is the magnitude of the electric field in V/m of the electromagnetic wave generated by the ECR source which is a function of the RF power and cross-sectional area of the cylindrical reactor, B is the magnitude of the magnetic field in Tesla, q is the electronic charge, m is the mass of a proton or deuteron or triton, d\dot{x}/dt is the particle velocity in x-direction in m/s, and, d\dot{y}/dt is the particle velocity in y-direction in m/s.

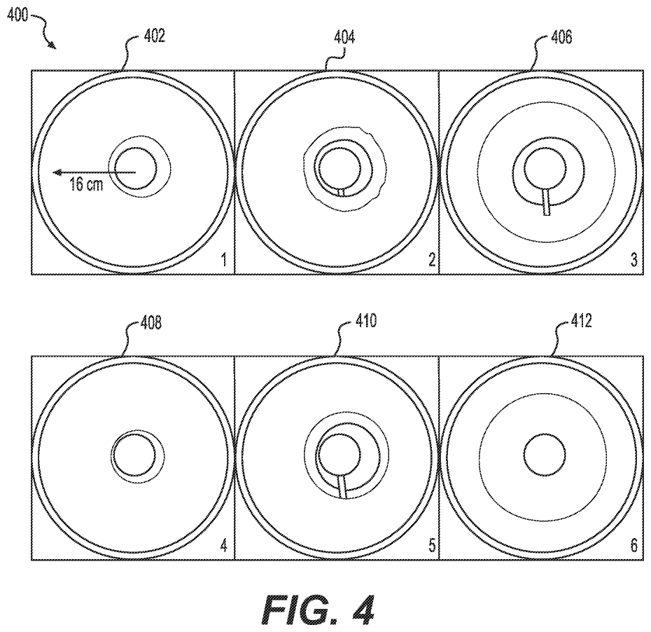

FIG. 4 is a sequence of spectroscopic measurements showing the expansion and rotation of neutrals at 518.77 nm (images 402, 404, 406) and ions at 442.6 nm (images 408, 410, 412), which shows that the ions and neutrals rotate and expand radially in the reactor in the same manner.

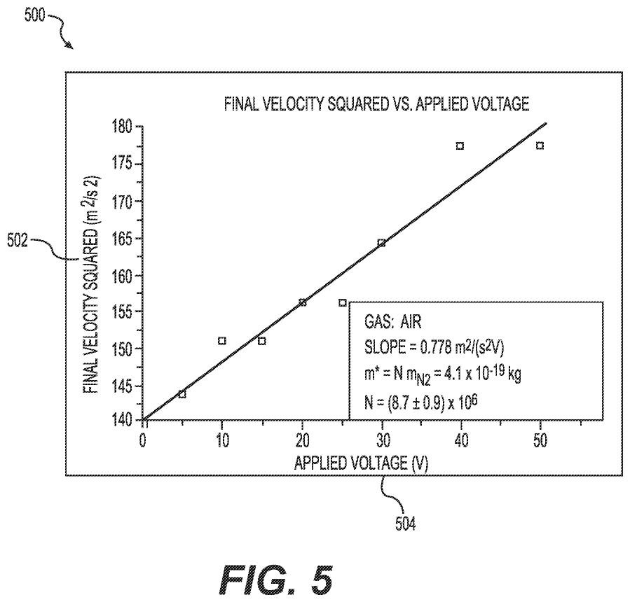

FIG. 5 is plot 500 of Final Velocity Squared 502 vs. Applied Voltage 504 for linear acceleration of the combined ions and neutrals, showing that as many at 8.7×10⁶ neutrals can be accelerated with each ion.

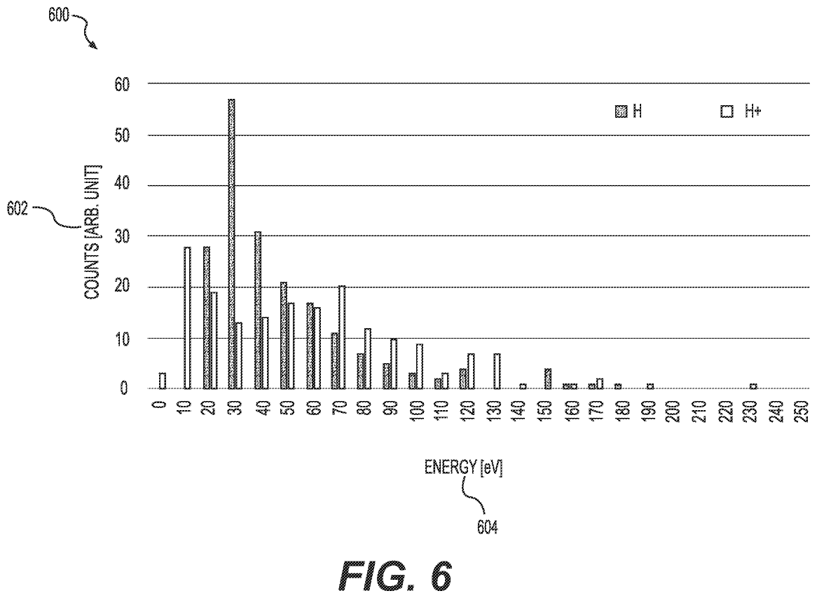

FIG. 6 is a distribution histogram 600 of counts (602) for different values of energy in eV (604) for H neutrals and H+ ions in the plasma created by the ECR/ICR system. The histogram shows that the H neutrals are the dominant component of the plasma.

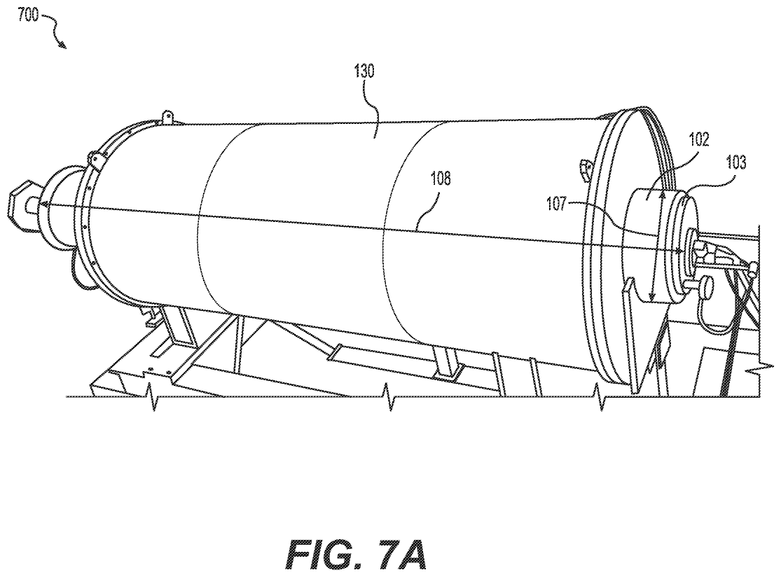

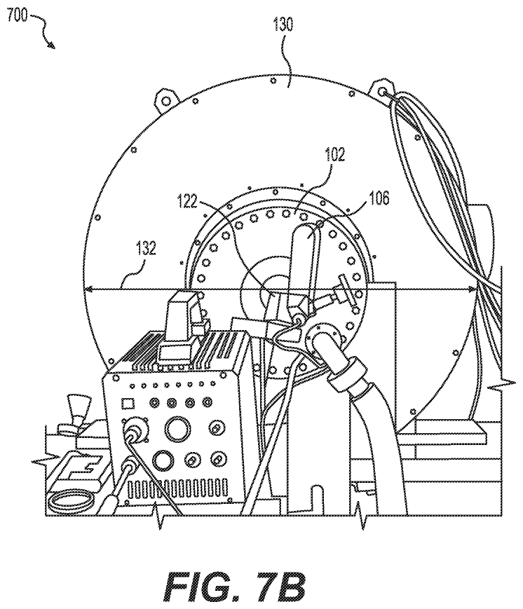

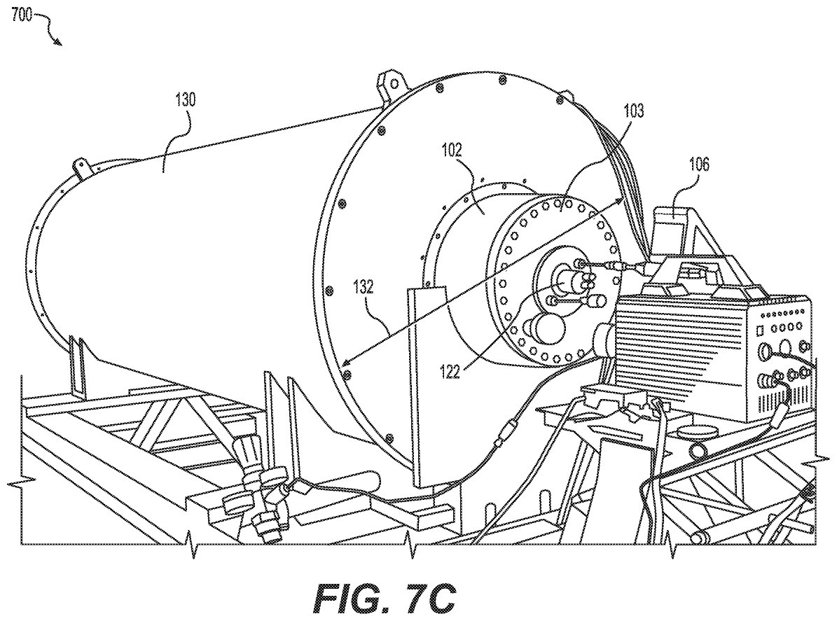

FIGS. 7A-C illustrate various side views of an exemplary ECR/ICR enabled cylindrical fusion reactor with a cryomagnetic coil according to one embodiment of the invention. FIG. 7A is a photograph 700 of a side view of a fusion reactor 130 with a cryomagnetic coil. The reactor has a length 108 of approximately 250 centimeters (cm) and an internal bore diameter 107 of approximately 35.6 cm. FIG. 7B is a photograph 710 of an end view of the fusion reactor, and FIG. 7C is a photograph 720 of a ¾ view of the fusion reactor.

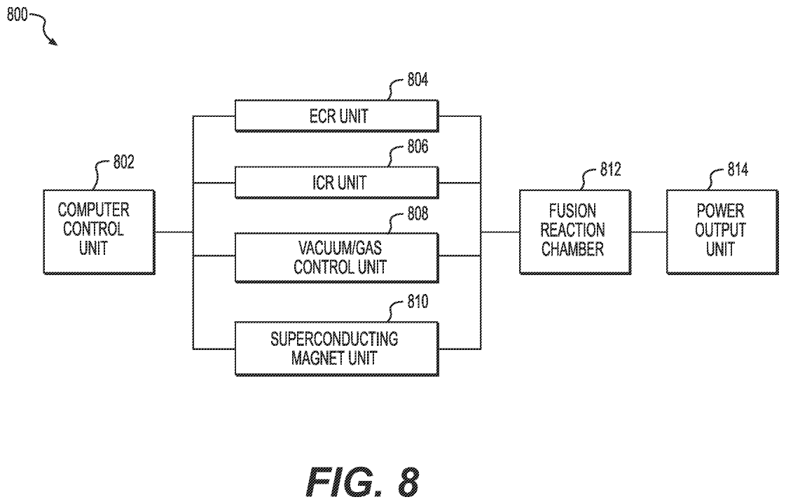

FIG. 8 is a schematic diagram 800 of an exemplary ECR/ICR enabled cylindrical fusion reactor according to some embodiments of the invention. ECR unit 804, ICR unit 806, vacuum/gas control unit 808, and superconducting magnet unit 810 are controlled by computer control unit 802. The outputs of units 804-810 interact in fusion reaction chamber 812 as discussed above, and the output of the fusion reaction chamber is converted into electrical power by power output unit 814.

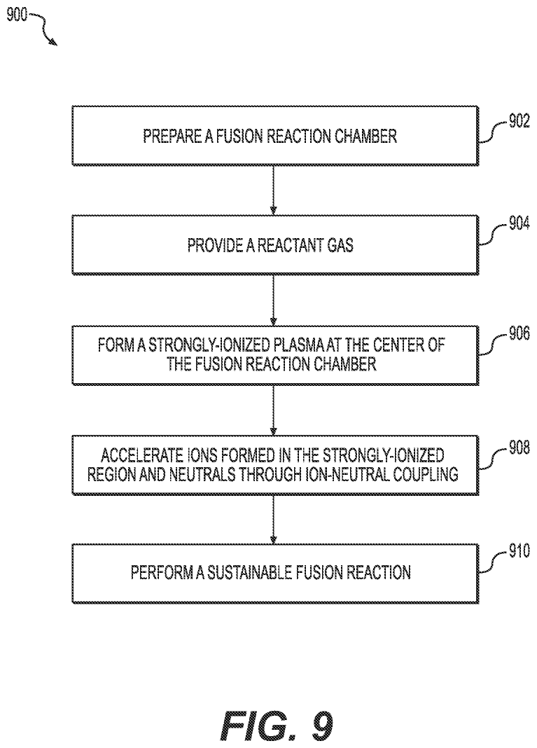

FIG. 9 is a flow diagram of an exemplary process 900 for instantiating a fusion reaction. At step 902 a fusion reaction chamber is prepared (such as by providing a target in the chamber and creating a vacuum in the chamber). At step 904 a reactant gas is provided in the chamber. At step 906 a weakly ionized plasma is formed at the center of the fusion reaction chamber with the ECR and ICR operations as discussed above. At step 908, ions formed in the plasma are accelerated, and neutrals in the chamber are accelerated by the ions through ion-neutral coupling. At step 910, a sustainable fusion reaction is performed by collision of plasma particles with a target in the chamber.

The rate of thermonuclear fusion in plasmas is governed by barrier penetration. The barrier itself is dominated by the Coulomb repulsion of the fusing nuclei. Because the barrier potential appears in the exponent of the Gamow formula, the result is very sensitive to the effects of screening by electrons and positive ions in the plasma. Screening lowers the Coulomb barrier and thus enhances the fusion rate. The rate of fusion per volume per unit time may be expressed by:

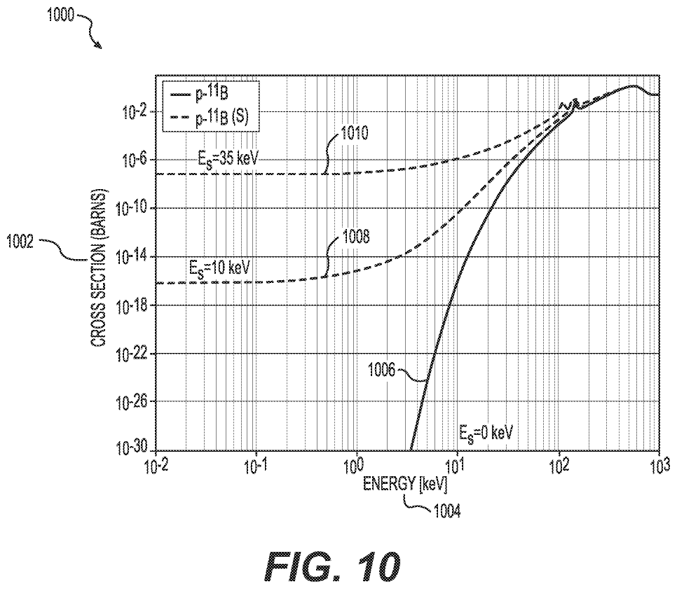

dN/dT=n₁n₂σv (eq 6)

where n₁ and n₂ are the densities of the respective reactants, σ is the fusion cross section in cm² at a particular energy, and v is the relative velocity between the two interacting species in m/s. The product (σ v) may be increased by reducing the coulombic barrier. In some embodiments, the fusion cross section may be between about 10⁻³⁰ cm² and about 10⁻⁴⁸ cm², and in some other embodiments, between about 10⁻²⁸ cm² and about 6×10⁻²⁴ cm². In some embodiments, the cross section is dependent on the type of fusion reactants and/or the electron screening energy. In some embodiments, the relative velocity between two fusion reactants is between 10⁶ m/s and 10⁸ m/s, and in some other embodiments, between about 10³ m/s and about 10⁵ m/s. In some embodiments, a screening field can significantly increase the cross section, particularly at low reactant energy, as shown in FIG. 10 for the reactant species hydrogen and boron.

FIG. 10 is a plot 1000 of fusion cross section (1002) for hydrogen ion-boron (p-¹¹B) as a function of reactant energy (1004) without any screening energy (solid line 1006) with a screening energy Eₛ of 10 keV (dashed line 1008), and with a screening energy Eₛ of 35 keV (dashed line 1010). As shown, the fusion cross section 1002 is significantly increased as the screening energy Eₛ is increased.

In some embodiments, a reduction to the coulombic barrier may result in a reaction rate that is about 10¹⁷ to about 10²² fusion reactions per second per cubic centimeter along the reactor wall.

An electron-rich region may be formed near the confinement wall to provide a screening effect between colliding nuclei. In some embodiments, electron emitters may be used to provide free electrons to this region. Emitters may be energized optically (e.g., using a laser), by frictional, conductive, convective or radiative heating by the plasma in the reactor, radio frequency (RF) heating and/or by Joule heating.

Within the electron-rich region, the density of electrons may be on order of about 10¹⁰ cm⁻³ to about 10²³ cm⁻³, and in some cases, the density of electrons is on the order of about 10²³ cm⁻³ within this region. In some embodiments, the density of neutrals in the electron-rich region may be about 10¹⁶ cm⁻³ to about 10¹⁸ cm⁻³, and in some cases, the neutrals density within the confinement region is on the order of about 10²⁰ cm⁻³. Positive ions may be found at a much lower density than neutrals within the electron-rich region. In some embodiments, the density of positive ions is about 10¹⁵ cm⁻³ to about 10¹⁶ cm⁻³. In some embodiments, the ratio of electrons to positive ions within the electron-rich region is in the range of about 10⁶:1 to about 10⁸:1.

The radial thickness of the electron-rich region may be characterized as the region in where most of the electron gradient exists. In some embodiments, the electron-rich region is in a range of about 50 nanometers (nm) to about 50 micrometers (um), in some cases, the electron-rich region is in a range of about 500 nm to about 1.5 um.

Within the electron-rich region, e.g. about 1 um away from the confining wall, there may be a strong electric field. In some embodiments, the electric field within the electron-rich region (or confinement region) can be in the range 10⁶ V/m to 10¹² V/m. In some embodiments, the temperature of electrons in this region is about 10,000 Kelvin (K) to about 50,000 K, and in some embodiments, about 15,000 K to about 40,000 K. However, the average kinetic energy of all particles in the electron rich region is below approximately 5000 K due to the lower mass of electrons as compared to the ion mass or neutral mass.

In some embodiments, creating, modifying, or utilizing effects that have negative (attractive) potentials can be used to lower or reduce the Coulomb barrier. In some embodiments, the potential of approaching nuclei has a substantially lowered Coulomb barrier for tunneling.

TABLE 1
Fusion reactions and their corresponding
theoretical reaction energy

| Reaction | Reaction energy (MeV) |
|---|---|
| D-D | 3.27 |
| D-T | 17.6 |
| H⁺-¹¹B | 8.7 |
| ³He-³He | 12.86 |
| D-³He | 18.3 |
| H⁺-⁷Li | 17.2 |
| D-⁶Li | 22.4 |

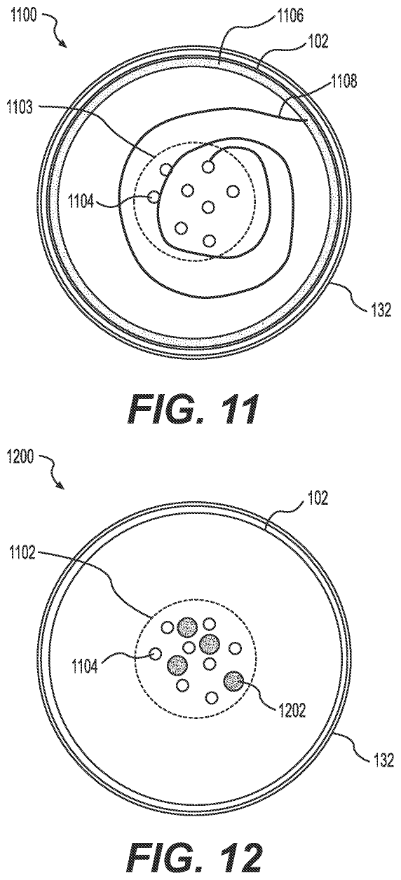

FIG. 11 illustrates a cross-sectional view of a cylindrical reactor 1100 having a wall 102 surrounded by a superconducting magnetic coil 132. An electron emitting material 1106 (e.g. LaB₆) is coupled to or coated on an inner surface of the reactor wall 102, in accordance with some embodiments of the invention. The electron emitting material on the inner surface of the reactor wall provides screening and lowers the coulomb barrier between fusion reactants.

In accordance with some embodiments, the plasma 1103 within the reactor containing the accelerated ions and neutrals 1104 via ion-neutral coupling will rotate within the chamber along a trajectory 1108 and collide with and heat the electron emitting material (e.g., lanthanum hexaboride) placed on or adjacent to the inner walls of the cylindrical reactor, thereby creating a “screen” of electrons near the reactor walls, thereby lowering the coulombic barrier for fusion reactions to occur. Lowering the coulombic barrier via electron screening is described in detail in the '306 application, which is incorporated by reference herein in its entirety.

In some other embodiments, the electrostatic repulsion between fusion reactants can be screened via a dense collection of electrons generated by lining the inner surface of the reactor wall of the rotating plasma with a thermionic emitter, such as lanthanum hexaboride (LaB₆), thoriated tungsten (W), tantalum (Ta), etc. This dense electron collection is formed as emitted electrons are compressed at the inner surface of the reactor wall by the neutrals in the rotation plasma, as shown in FIG. 6. As the electrons are compressed by the rotating neutral molecules, the resultant electric field reduces the effective electrostatic repulsion between fusion reactants, increasing the probability of quantum mechanical tunneling and thus the fusion reaction rate.

In accordance with various embodiments, the B-field can be in a range of 0 to 20 Tesla, and the e-field can be in the range of 0 to 10⁸ V/m. By utilizing the system described above, the energy and temperature required to generate and sustain fusion reactions can be significantly decreased to approximately 1500 to 5000 degrees Celsius at the reactor wall. In some embodiments, the temperatures within the cylindrical reactor will be characterized by a steep temperature gradient such that the temperature will be highest (e.g., millions of degrees Celsius) in the center of cylindrical reactor access and steeply cool down in the outward radial direction toward the inner surface of the reactor wall, where most of the fusion reactions take place. In the vicinity of the inner surface of the reactor wall, the temperature is in a range of 1500 to 5000 degrees Celsius, in some embodiments. This steep temperature gradient is possible because the degree of ionization and neutral density changes as a function of the reactor radius in the system. Near the center of the reactor, the plasma is weakly ionized, meaning the temperature (defined technically as the average kinetic energy of all particles) is dominated by the kinetic energy of the plasma, which is on the order of 10⁶ to 10⁹ degrees Celsius. Moving outwardly from the center, the degree of ionization decreases so that the high ion kinetic energy contributes very little to temperature as is defined technically. Since the neutral particles are not accelerated by the ICR wave, they remain relatively cool in the range of 25 to 1500 degrees Celsius as compared to the ions. It is this gradient in degree of ionization and neutral density that enables the presence of the steep temperature gradient between the center and the walls.

Based on experimental results achieved in previous generation reactors design and configurations as described in the Ser. No. 15/594,491 patent, power output to power input ratios of 1.3 or greater were achieved. In the present fusion reactor design using ECR and ICR, as described herein, the generation of ions and acceleration of ions can be performed even more efficiently than the previous generations of reactor designs. Thus, it is expected that power output to power input ratios for the present reactor utilizing ECR and ICR will exceed 1.3. The use of ECR and ICR devices, which utilize an AC field to drive particles to higher energies, can generate fusion reactions more efficiently. The ICR wave can couple efficiently to the rotation of ions in the high kinetic energy (from several keV to MeV) range, as compared to DC acceleration. In the ideal case, all of the wave energy can be converted to kinetic energy of the ions by resonantly pushing the ions to higher and higher velocities. Based on this principle, we expect the power output to power input ratio in various embodiments in this present disclosure to be greater than previous demonstrated systems that employ the same principle of using a plasma rotor to produce heat via fusion reactions.

In some embodiments, a fusion reaction can be further facilitated through an addition of particles to the plasma composition, creating what is commonly referred to as “dusty plasma”. These particles with a size ranging from millimeters to nanometers comprise multiple negative charges and atomic masses. In some embodiments, the particles comprise thermionic materials such as lanthanum hexaboride (LaB₆), thoriated tungsten (W), tantalum (Ta), etc. In some other embodiments, the particles comprises a mixture of aforementioned particles. In some embodiments, these particles have a size of micrometers, as shown in FIG. 7. Because of their charges, the dust particles are also controllable by electric and magnetic fields with a resonant frequency as defined in equation 1.

### Dusty Plasma Embodiment

FIG. 12 is a cross-sectional view of an ECR/ICR enabled cylindrical fusion reactor 1200 with a superconducting magnet coil 132 using dusty plasma 1102 for fusion reactions. In this embodiment the dusty plasma contains ions 1104 and LaB₆ macroparticles 1202.

Advantageously, the particles 1202 can act like “collisionless particles” whose orbits are not affected by collisions with neutrals or ions because of the differences in masses. These particles with charges only at their surfaces remain neutral in the bulk and can be driven by the Lorentz force. In some embodiments, a particle comprising thermionic materials is also an electron emitter. Therefore, the particle comprises the necessary reactants for proton-boron fusion (e.g., LaB₆), in addition to a collection of free electrons created by thermionic emission. The free electrons at the surface of the particles screen the electrostatic repulsion between the fusion reactants, increasing the probability of quantum mechanical tunneling and thereby increasing the fusion reaction rate. Because of the large size of the dusty particle compared to the fusion reactants, a particle can be the site for multiple fusion reactions.

In some embodiments, the particles can also interact with the solid fusion reactants embedded or attached to a confining region (e.g., inner surface of the reactor). Since the particle is a solid material, this would yield a high density solid-to-solid fusion reaction, increasing the fusion reaction rate.

Dusty plasma theory explains how a fusion reaction is facilitated by the properties of particle clusters. A dusty plasma contains both electrons and neutrals so that it comprises multiple charges and atomic masses. These macroparticles can be driven by electric and magnetic forces just like plasma particles. As discussed above, dusty particles behave like charged particles in a collisionless environment. The particle's large mass makes it immune to momentum changes induced by collisions with surrounding neutrals or ions. In addition, the free electrons in these charged particles can reduce the repulsion between fusion reactants, thereby increasing the probability of quantum mechanical tunneling and the fusion reaction rate.

When an electromagnetic wave at a certain frequency is introduced into a plasma, it propagates at a speed equal to the speed of light divided by the refractive index of the plasma. At the point of a plasma resonance the group velocity of this wave is reduced to zero; energy is piled up and a large field is formed. This is a simple explanation of how energy is efficiently passed onto the plasma particles at resonance. By using electron and ion cyclotron resonances, 1-100 watts of power have been used successfully to produce a plasma and 1-2 watts of beam power can be used to produce fusion processes, instead of multi-kilowatts of input energies. Monopole and spiral antennae have been used in a number of experiments to launch EM waves in a plasma chamber with an axial magnetic field.

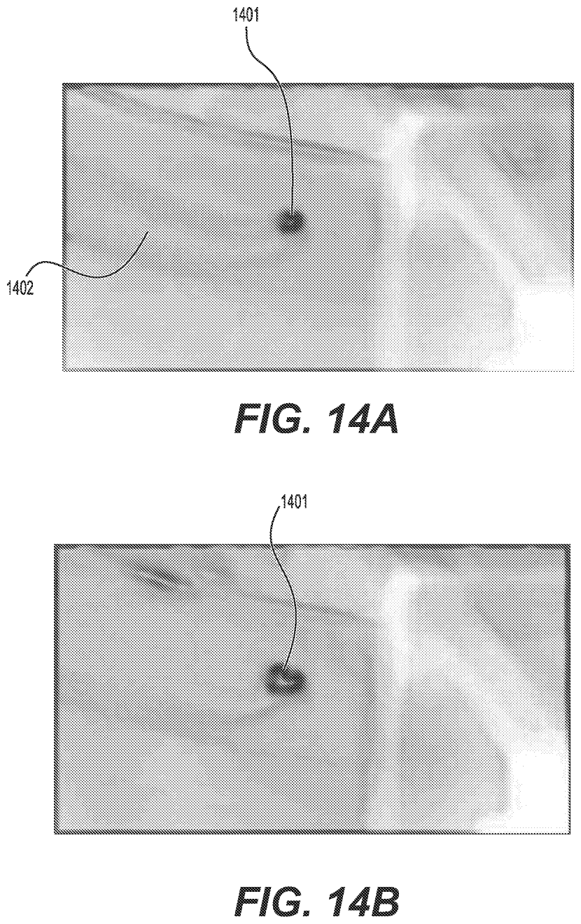

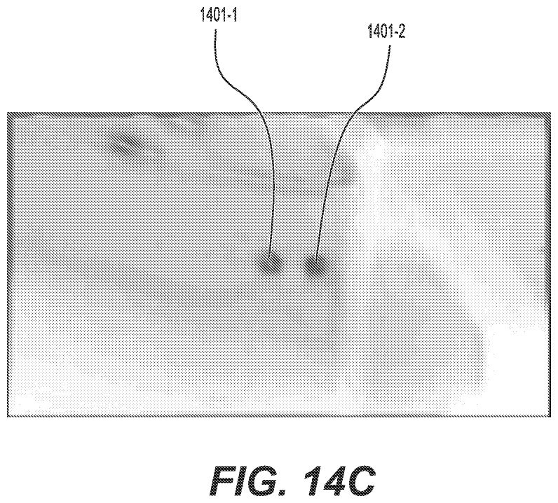

The following calculation shows that fusion reactions must have occurred to give the energy for the breakage of a floating piece of emitter as shown in FIGS. 14A-14C.

Referring to FIG. 14A, consider a piece of LaB₆ 1401 (400 microns in each dimension) floating in a gas stream 1402 but not physically connected to any electrode. It is at a temperature such that it is emitting electrons. The energy W, required to split this piece into two equal parts within 100 μsec, can be calculated from the flexural strength of LaB₆ which is equal to 200 MPa or 2×10⁸ N/m². W is calculated to be 0.015 J by multiplying this strength by the volume of LaB₆. Assuming each fusion event yields 9 MeV and is 33% efficient or 5×10⁻¹³ J towards contributing to the splitting energy, the number of required fusion reactions is 3×10¹⁰.

We now show that the number of fusion reactions N taking place in 100 μsec within the volume of the floating piece of LaB₆ is comparable to this required number. This number N is calculated from the fusion rate dN/dt times the time interval and volume:

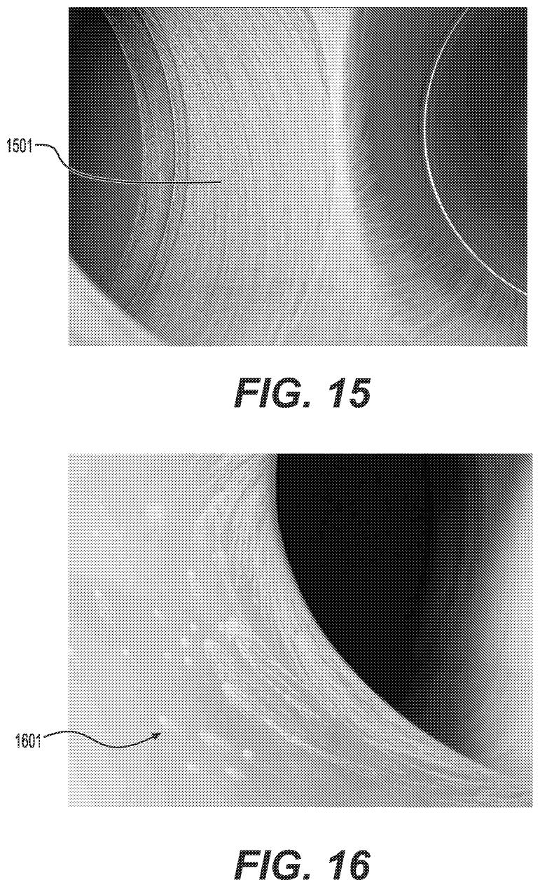

N=dN/dt ΔtV=NₚN_{b} σvΔtV=5×10²⁵/s·m³ 7×10⁻¹¹×10⁻⁴=3×10¹⁰ (eq 7)

where σ=10⁻³⁵ m² has been used, which corresponds to Eₛ ˜28 keV or n₁ ˜6×10¹⁹ cm⁻³. It is interesting to note that the fusion reactions in this small piece are more active than other places and reach the critical electron density fluctuation earlier to cause the breaking up. It then grows larger, as shown in FIG. 14B, and splits into equal pieces 1401-1 and 1401-2, as shown in FIG. 14C. These pieces make a cyclotron orbit and impress marks 1501 on the inner wall of the reactor, as shown in FIG. 15. They also leave fusion products 1601 in the chamber when they collide with the wall, as shown in FIG. 16.

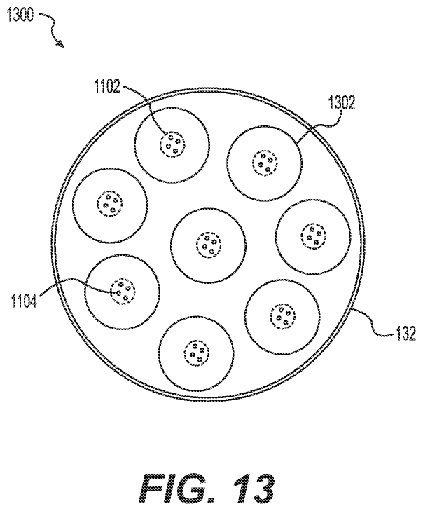

In some other embodiments as shown in FIG. 13, since the superconducting magnet 132 provides a uniform magnetic field, a plurality of cylindrical vessels 1302 can be placed along the axis of the cylinder enclosed by the superconducting magnet coil, with radius matching the Larmor orbit of the ions enclosed by the cylindrical vessels. Each of the reactor vessels 1302 can provide fusion reactions with increased number of reaction sites. In some embodiments, the reaction vessels each comprises an ECR and an ICR antenna. In some embodiments, all the ECR and ICR antennas are coupled to the same ECR and ICR sources, respectively. FIG. 13 shows an ECR/ICR enabled cylindrical fusion reactor 1300 with 8 cylindrical reaction vessels 1302 enclosed by a superconducting magnet coil 132 to increase the number of reaction sites.

In some embodiments, there can exist a density gradient of reactant as a function of radius, ρ(r), such that the density of reactant near the inner surface of the cylindrical reactor is higher than the density near the center of the reactor. This can be achieved through a process commonly known as outgassing, in which gases (such as hydrogen or deuterium) are desorbed from the reactor wall as it heats up. In some embodiments, the reactor wall is made of palladium which can dissolve hydrogen or deuterium. Because of the higher density near the inner surface of the reactor wall compared to the center, neutral particles will naturally diffuse towards the center (Fick's Law). This becomes the mechanism by which ions are replenished in the center region. Since the reactant gases are continuously pumped out of the reactor through the center portion through a valve (not shown) within the reactor, a density gradient is formed with the reactor wall as a gas source. This density gradient has several advantages. A differential pumping scheme can be used to further strengthen this density gradient. In some embodiments, turbo pumps can be used to evacuate gases in the center and inject them at the walls. A system of getter pumps can be used in a similar fashion.

The ions can be accelerated in the center region to very high velocity because the pressure (density) is low. Further, near the center, collisions and charge exchange with neutrals are negligible. As the ions being accelerated and the Larmor radius increase, they inevitably reach the inner surface of the cylindrical reactor, where the pressure (density) is higher and collisions are more common. This higher density of reactants at the inner surface of the cylindrical reactor allows more fusion reactions to occur. Additionally, through ion-neutral coupling, the ions can transfer momentum elastically to neutrals. In some embodiments, velocities of the ions (H⁺ or D⁺) are completely transferred to the neutrals (H⁰ or D⁰). The neutral molecules with high kinetic energy can then collide with the inner surface of the reactor. Since the inner surface also contains reactants, this collision will further increase the fusion reaction rate through the gas-to-solid fusion reaction.

Thus, as described herein, in some embodiments, a method and apparatus for fusion reaction comprises an ICR device having a radio frequency (RF) power supply to output a desired RF wave, whereby small amount of ionic molecules generated inside the reactor resonate when an electromagnetic wave applied is equal to the ion cyclotron frequency. A relatively small number of ions can drive large numbers of reactant neutrals to rotate the neutrals, along with the ions, through ion-neutral coupling.

In some embodiments, the heat generated from fusion reaction can increase the temperature of the inner surface of the reactor wall (e.g., up to 1400 degrees Celsius for a stainless steel reactor and 1600 degrees Celsius for a Titanium reactor). This higher temperature can increase the rate of outgassing, which increases the supply rate of the reactants into the reactor. This high supply rate of the reactants leads to a higher gas-to-gas as well as a higher gas-to-solid fusion reaction rate, which further increases the temperature and the number of electrons near the inner surface of the reactor, leading to a positive feedback effect. This positive feedback can produce a self-sustaining fusion reaction, also known as “ignition”, in which the Q-value becomes infinity after the fusion reaction becomes self-sustaining and no further input energy is required.

In some embodiments, an ion can obtain an electron from a first neutral nearby and becomes a second neutral itself. The second neutral retains its kinetic energy and momentum but without the experience of the magnetic force components (qv×B) of the Lorentz force. This second rotating neutral can have a strong centrifugal force towards the inner surface of the reactor. In some embodiments, this force is similar to a gravitational force when a star undergoes a gravity collapse, which can be of the order of the Coulomb repulsion force. This process can be used to increase the probability of fusion among two neutral molecules.

In all these embodiments, the fusion by-products, such as, but not limited to heat, neutrons, electromagnetic radiation, atomic or molecular by-products such as helium isotopes, can be extracted. The by-products can provide electricity, be converted directly into electricity, be valuable in and of themselves, or be used for additional processes. Additionally, the magnetic field at the ends of the superconducting reactor can be formed in such a way as to facilitate the extraction of fusion by products.

Plasma Resonant Cone

Fundamental studies by the present inventors have revealed collective resonant behavior in the coupling between electrons and ions. When a large number of charged particles are present as in a plasma wave, processes between ions and electrons dictate the movements of such charged particles. A large number of like charges can move together in unison even though they do not do so when fewer numbers are involved. The collective behavior in the presence of waves is very different from the behavior between a pair of charges. This is due to the fact that an equally large number of opposite charges also participate in such wave motions.

A magnetized plasma has been selected to demonstrate that such collective behavior indeed influences the fusion process, which requires fusing particles to be in close proximity so as to make possible tunneling through the quantum barrier—which is the only barrier to fusion. Electron and ion cyclotron resonances are employed so that 10-100 watts of power are used for this study of a fusion process instead of multi-kilowatts of input energies. With this experimental arrangement fusion processes were studied repetitively in space and time and digital sampling is utilized to great advantage.

The superconducting magnet setup provides a favorable environment for generating plasmas in an efficient way using ˜100 watts of RF power at frequencies in the range of ion resonances (ICR) between ion cyclotron and lower hybrid resonances. This is achievable due to the stable magnetic field and small system size (as compared to Tokamak type fusion reactors). It is important to note here that ICR is acting as a catalyst for enhancing the beam-target fusion reaction. While in this case fusion requires an external deuterium ion (D+) beam source, the presence of the ICR plasma acts like an extended target rich with D+ ions, which plays an important role in the fusion reaction because the ions are ultimately responsible for fusion and the presence of the electrons helps to overcome the Coulomb repulsion barrier.

The ICR cone is generated by high electric fields at its boundaries as a result of wave propagation in a magnetized plasma. Due to the special characteristics of the cone, the group velocity of the RF electrostatic wave propagates towards the apex of the cone where the target is located. The axial ion beam is also aimed at the target, making it a place where all electrons and ions converge. Optical cameras have shown that this is the most intense region with high optical radiation.

The following equation describes the D-D fusion reaction having the fusion products shown on the right-hand side of the arrows.

₁²D+₁²D→₁³T(1.01 MeV)+p(3.02 MeV)→₃³He(0.82 MeV)+n(2.45 MeV) (eq. 8)

The resonant frequency of ions in the presence of a magnetic field is given as follows:

ω=qB/m

where ω=2πf=angular resonant frequency (rad/s), f=linear resonant frequency (Hz)

q=charge of ion [Coulomb]=1.6×10⁻¹⁹ C

B=external applied magnetic field=900 Gauss

m=mass of Deuterium ion=3.34×10⁻²⁷ kg

The above equation suggests that for a given magnetic field of B=900 Gauss, the resonant frequency of D+ is 687 kHz.

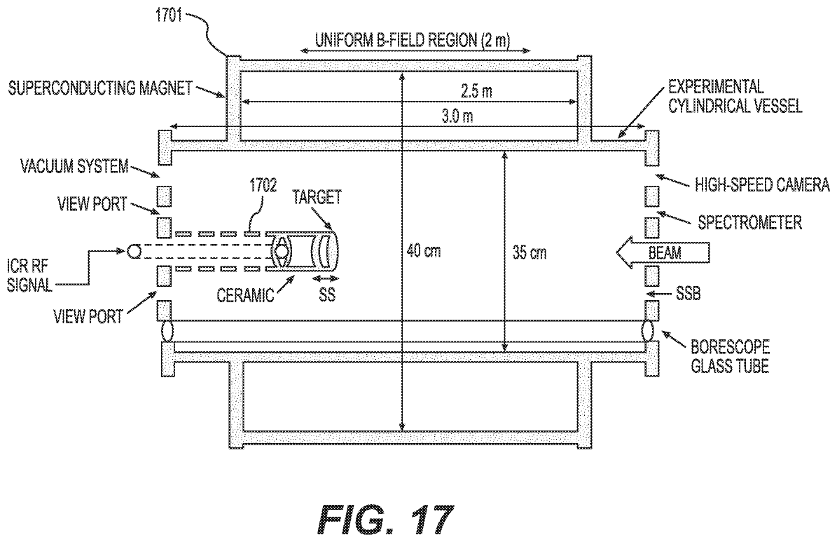

The schematic of the experimental setup is depicted in FIG. 17. The cylindrical system is a cryogenic superconducting magnet 1701 about 5 m long and having a bore-size approximately 40.0 cm in which is inserted a 3 m long cylindrical tube 1702 of 35 cm diameter that acts as a vacuum vessel for the plasma generation and beam-target fusion experiment. RF electromagnetic waves of typical frequency 14.685 MHz are launched through a co-axial launcher “ICR launcher” of diameter about 8 cm having a ceramic high-voltage standoff followed by a stainless-steel disk (˜7 cm diameter) attached at the end. The stainless-steel disk serves a dual purpose as a target for the D+ ion beam interaction thus causing D-D fusion reaction without and with the ICR plasma environment. A D+ ion source is mounted on the right-hand-side which consists of a 2.45 GHz electron cyclotron source for generating plasma and the ions are ejected by a high voltage (10 kV-40 kV) extraction system. Typical spot-size of the ion beam is about 1 cm for the 40 keV beam energy and the typical beam current varies between 0.1-0.5 mA. However, the beam current varies depending on the beam extraction voltage and the power of the microwave plasma generator. The vacuum system consists of a rotary pump and two turbo pumps to achieve a vacuum condition of the order of 10⁻⁵ Torr.

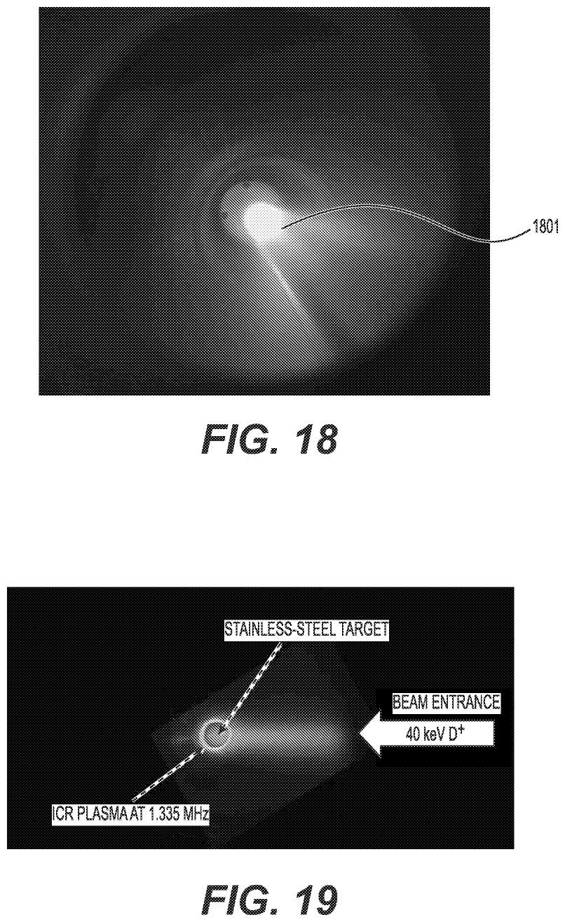

As shown in FIG. 18, an ICR plasma cone 1801 of deuterium gas is generated by launching an RF wave through the coaxial launcher. The plasma cone configuration was obtained using an excitation frequency of 14.685 MHz.

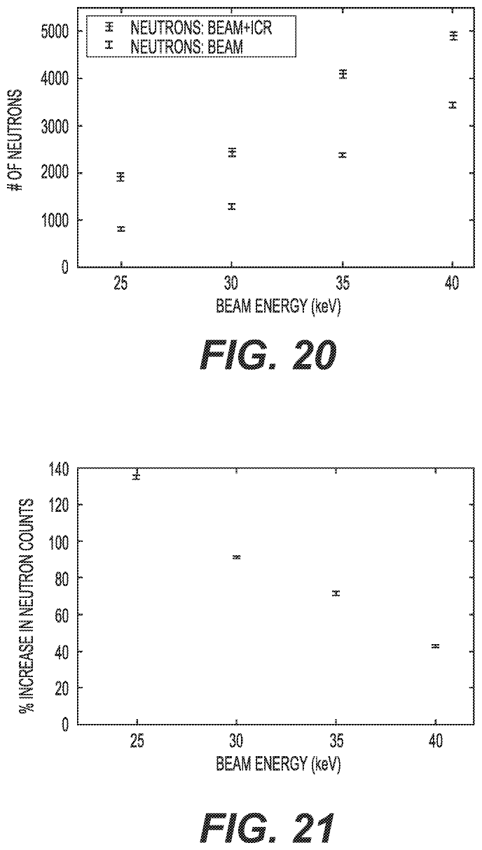

FIG. 19 shows the interaction of a 40 keV D⁺ ion beam with the stainless-steel target in the presence of an ICR plasma at 1.335 MHz. In the experiment, D⁺ ion beams of 25, 30, 35 and 40 keV were aimed at the stainless-steel target in the presence of the ICR plasma, and without the ICR plasma. As shown in FIGS. 20 and 21, the presence of the ICR plasma significantly increased the number of fusion neutrons produced by the D⁺ ion beam—stainless-steel target interaction. FIG. 20 shows the number of fusion neutrons produced by beam energy with and without the ICR plasma, and FIG. 21 shows the percentage increase in fusion neutron counts due to the presence of ICR plasma. FIG. 21 shows the ICR plasma contribution is remarkably large (134% increase) at the lowest beam energy (25 keV).

The interpretation of fusion enhancement due to ICR plasma witnessed in the beam-target experiment discussed above can be explained as follows. The near-field radiation of an oscillating charge in a magnetized plasma is an electrostatic wave. Along a certain angle with respect to the axial magnetic field, the group velocity is zero, resulting in a large electric field which has been measured experimentally to be two orders of magnitude above the externally imposed field. This enhanced self-consistent wave field drives positively charged particles together in an ion resonance (e.g. lower hybrid resonance) where the wavelength is short. If such resonant fields occur at the apex of the resonant cone where a D+ ion beam interacts with a D target, fusion processes are observed to increase because the Coulomb barrier is reduced due to the collective presence of electrons and ions.

Further Discussion re: Ion-Neutral Coupling

As discussed above, in some embodiments, ion-neutral coupling is utilized to accelerate neutrals within the cylindrical chamber. The following equations describe how neutrals through their frequent collisions with ions can be made to follow the external electromagnetic excitations.

$$\begin{matrix}{Mn}_{i} \frac{\partial {\underline{v}}_{i}}{\partial t} = {qn}_{i} ( \underline{E} + {\underline{v}}_{i} \times \underline{B} ) - ∇ {p}_{i} + {P}_{ie} + {P}_{io} & ( C1 ) \\ {mn}_{e} \frac{\partial {\underline{v}}_{e}}{\partial t} = {qn}_{e} ( \underline{E} + {\underline{v}}_{e} \times \underline{B} ) - ∇ {p}_{e} + {P}_{ei} + {P}_{eo} & ( C2 ) \\ {Mn}_{o} \frac{\partial {\underline{v}}_{o}}{\partial t} = - ∇ {p}_{o} + {P}_{oe} + {P}_{oi} & ( C3 )\end{matrix}$$

where M is the mass of ion and neutrals and m, the mass of electrons, n_{i,o,e} are the densities of ions, neutrals and electrons, v_{i,e} the velocities of ions and electrons, p_{i,e} are the pressures of ions and electrons, E is the electric field, B is the magnetic field, the Pᵢₑ is the momentum change due to ion-electron interaction (note that Pᵢₑ=−Pₑᵢ), Pᵢₒ is the momentum change due to ion-neutral collisions and Pₑₒ is the momentum change due to electron-neutral collisions (similarly Pᵢₒ=−Pₒᵢ and Pₑₒ=−Pₒₑ).

Neglecting the viscosity tensor and (v·v̅) v terms and adding (C1) and (C2), the interaction terms due to E field are cancelled and we have after neglecting Pₑₒ due to the small mass of electrons:

$$\frac{\partial }{\partial t} ( {Mn}_{i} {\underline{v}}_{i} + {mn}_{e} {\underline{v}}_{e} ) = q [ ( {n}_{i} {\underline{v}}_{i} - {n}_{e} {\underline{v}}_{e} ) \times \underline{B} ] - ∇ ( {p}_{i} + {p}_{e} ) + {P}_{in} \qquad ( C4 )$$

Equation (C4) can be written as

$$ρ \frac{\partial \underline{v}}{\partial t} = \underline{j} \times \underline{B} - ∇ ( {p}_{i} + {p}_{e} ) + {\underline{P}}_{in} \qquad ( C5 )$$

where ρ=nᵢM+nₑm=n(M+m) is the combined ion-electron density, and the average velocity and effective electric current are (assuming n˜nᵢ˜nₑ).

$$\underline{v} = \frac{1}{ρ} ( {n}_{i} M {\underline{v}}_{i} + {n}_{e} m {\underline{v}}_{e} ) \approx \frac{M {\underline{v}}_{i} + m {\underline{v}}_{e}}{M + m} \\ \underline{j} = q ( {n}_{i} {\underline{v}}_{i} - {n}_{e} {\underline{v}}_{e} ) \approx qn ( {\underline{v}}_{i} - {\underline{v}}_{e} ) \qquad ( C6 )$$

Now, consider the interactions between the charge current and the neutrals. Their equations can be written as

$$\begin{matrix}\begin{matrix}Neutrals & {Mn}_{0} \frac{\partial {\underline{v}}_{0}}{\partial t} = - ∇ {p}_{0} + {\underline{P}}_{ni}\end{matrix} & ( C7 ) \\ \begin{matrix}Charged & ρ\end{matrix} \frac{\partial \underline{v}}{\partial t} = \underline{j} \times \underline{B} - ∇ ( {p}_{i} + {p}_{e} ) + {\underline{P}}_{in} & ( C8 )\end{matrix}$$

Adding (C7) and (C8), the interaction terms are cancelled and we obtain

$${Mn}_{0} \frac{\partial {\underline{v}}_{0}}{\partial t} + ρ \frac{\partial \underline{v}}{\partial t} = \underline{j} \times \underline{B} - ∇ ( {p}_{i} + {p}_{0} + {p}_{e} ) \qquad ( C9 )$$

Equation (C9) shows that the neutrals are influenced by electric and magnetic fields as a result of collisions between charges and neutrals. Optical monitoring of Argon ions and neutrals in FIG. 4 shows that they do rotate together and expand radially outward at the same rate. Another experiment on the linear acceleration of a combined mixture of neutrals and ions also shows that they move together with an effective mass of N*m where N* is greater than 10⁶, as shown in FIG. 4. In FIG. 4, images 402, 404, 406 show a sequence of expanding neutrals at 518.77 nm and images 408, 410, 412 show a corresponding sequence of ions at 442.6 nm.

Computer modeling and laboratory experiments with higher current drives and larger chamber diameters have shown that neutrals can be accelerated to 100 eV range of energies. This implies much higher fusion cross sections than what can be achieved with our present rotating neutrals of energy in the range of 0.2 to 10 eV.

While various embodiments of the invention have been described above, it should be understood that they have been presented by way of example only, and not by way of limitation. Likewise, the various diagrams may depict an example architectural or configuration, which are provided to enable persons of ordinary skill in the art to understand exemplary features and functions of the invention. Such persons would understand, however, that the invention is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described exemplary embodiments.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein.

For example, in various alternative embodiments, the combination of ECR and ICR devices can be utilized for the following additional applications: Neutron generation, helium-3 generation, radioisotope generation, gamma generation, large area ion (source) extraction, neutral beam injection, plasma propulsion thruster, etc.

In one specific embodiment, the ion energy can be tuned to an optimal value for the production of neutrons using the deuterium-deuterium (D-D), deuterium-tritium (D-T), deuterium-lithium6 (D-Li6), deuterium-beryllium (D-Be), or hydrogen-lithium? (P-Li7) reactions. Such optimal energy will be determined by the peak of the fusion cross-section for the relevant reactions. For example, the (D-T) reaction has an optimal deuteron energy of around 100 to 200 keV when striking a tritium target that is at rest. The fusion neutron yield is approximately 10¹¹ neutrons/second (n/s) for a 1 milli-ampere (mA) deuteron beam striking a titanium tritide target. Tuning of the ion energy can be achieved by varying the ICR wave amplitude (E-field) and the B-field to achieve a maximum ion energy (maximum Larmor radius) to be in the optimal energy range. This embodiment of the device has utility for generating radioisotopes (e.g. Mo-99) in which a blanket of uranium or molybdenum is placed on the outside of the reactor walls. The source of neutrons produced via the D-D or D-T reactions in this configuration will be primarily distributed near the reactor wall. These neutrons can cause fission in the uranium containing blanket to produce Mo-99. Similarly, the neutrons can cause activation of Mo-98 (either from natural abundance Mo or enriched) to produce Mo-99.

In another embodiment, the device can be used to produce gamma rays of energies 431 keV and 478 keV using the D-Li6 reaction and gamma rays of energies 410 keV, 718 keV, 1.02 MeV, and 1.44 MeV can be produced from the D-Be reaction. The gamma rays produced are monoenergetic and has utility in the following areas: calibration, food sterilization, oil exploration, cancer treatment.

In another embodiment, the ECR wave can generate a large volume of high density plasma inside the uniform region of the B-field. The high density plasma can be weakly or strongly ionized with a plasma density in the range of 10¹⁰ to 10¹⁵ electrons/cubic centimeter (n/cm³) depending on the power input of the ECR wave and the neutral gas density. An ion source can be attached to a separate reactor containing DC high voltage acceleration electrodes that could further accelerate the ions to energies in the range of 10 keV to 10 MeV for fusion reaction diagnostics. For this embodiment, it is possible to have multiple ECR wave applicators, or antennas, that are attached to the reactor to modulate the spatial variation in plasma density. For example, one can use the SAIREM Hi-wave or Aura-wave applicators for 2.4-2.5 GHz. Another method is to use an alumina ceramic (94% to 99.9%) cylinder coupled to a standard microwave waveguide.

What is claimed is:

1. A fusion reactor system, comprising:
a cylindrical reactor chamber;
a superconducting magnet surrounding the reactor chamber so to provide a uniform magnetic field along its axis;
a first electromagnetic wave generator coupled to a first antenna provided at one end of said reactor chamber configured to provide a first electromagnetic wave of a first frequency to said reactor chamber, the first electromagnetic wave and the uniform magnetic field acting together to excite a plurality of electrons of atoms in at least one reactant gas introduced into said reactor chamber to their electron cyclotron resonance (ECR) frequency so as to create a plurality of ions said reactant gas to form a plasma of ions and neutrals in said reaction chamber having a first radius of rotation within said reactor chamber; and
a second electromagnetic wave generator coupled to a second antenna provided at the other end of said reactor chamber configured to provide a second electromagnetic wave of a second frequency said reactor chamber, the second electromagnetic wave and the uniform magnetic field acting together to further excite the plurality of ions in the plasma to their ion cyclotron resonance (ICR) frequency so as to accelerate the plurality of ions and neutrals to an increased radius of rotation within said reactor chamber;
wherein said accelerated plurality of ions and neutrals interact with a target material in said reactor chamber to cause a fusion reaction to occur.

2. The fusion reactor system of claim 1, wherein the first frequency of the first electromagnetic wave is in a range of 2-560 GHz and the second frequency of the second electromagnetic wave is in a range of 1-350 MHz.

3. The fusion reactor system of claim 1, wherein a fusion reaction is caused by collisions of said accelerated plurality of ions and neutrals with said target material.

4. The fusion reactor system of claim 1, wherein said accelerated plurality of ions and neutrals further interact with said target material to form macroparticles in said plasma to create a dusty plasma.

5. The fusion reactor system of claim 4, wherein a fusion reaction is caused by interactions of sub-atomic and atomic particles within said macroparticles of said dusty plasma.

6. The fusion reactor system of claim 5, wherein a plasma resonant cone is generated by propagation of said second electromagnetic wave in said plasma, wherein said plasma resonant cone facilitates the concentration of fusing particles to be in close proximity so as to make possible quantum tunneling through the coulombic barrier.

7. The fusion reactor system of claim 1, wherein the reactor chamber comprises at least one of stainless steel and titanium.

8. The fusion reactor system of claim 1, wherein the target material comprises at least one of stainless steel and titanium.

9. The fusion reactor system of claim 1, wherein the at least one reactant gas comprises at least one of the following: hydrogen, deuterium, tritium, boron trifluoride, and borane.

10. The fusion reactor system of claim 1, wherein the cylindrical reactor chamber further comprises an electron emitting material so as to reduce a coulombic barrier of a fusion reaction, wherein the electron emitting material is coupled to or coated on an inner surface of the reaction chamber, wherein the electron emitting material comprises at least one of the following: lanthanum hexaboride (LaB6), thoriated tungsten (W), and tantalum (Ta).

11. The fusion reactor system of claim 1, wherein said reactor chamber further includes reflectors on each end thereof.

12. A method of fusion reaction comprising:
providing a cylindrical reactor chamber and a superconducting magnet surrounding the reactor chamber so to provide a uniform magnetic field along its axis;
providing a first electromagnetic wave of a first frequency to said reactor chamber, the first electromagnetic wave and the uniform magnetic field acting together to excite a plurality of electrons of atoms in at least one reactant gas introduced into said reactor chamber to their electron cyclotron resonance (ECR) frequency so as to create a plurality of ions said reactant gas to form a plasma of ions and neutrals in said reaction chamber having a first radius of rotation within said reactor chamber; and
providing a second electromagnetic wave of a second frequency said reactor chamber, the second electromagnetic wave and the uniform magnetic field acting together to further excite the plurality of ions in the plasma to their ion cyclotron resonance (ICR) frequency so as to accelerate the plurality of ions and neutrals to an increased radius of rotation within said reactor chamber;
wherein said accelerated plurality of ions and neutrals interact with a target material in said reactor chamber to cause a fusion reaction to occur.

13. The method of claim 12, wherein the first frequency of the first electromagnetic wave is in a range of 2-560 GHz and the second frequency of the second electromagnetic wave is in a range of 1-350 MHz.

14. The method of claim 12, wherein a fusion reaction is caused by collisions of said accelerated plurality of ions and neutrals with said target material.

15. The method of claim 12, wherein said accelerated plurality of ions and neutrals further interact with said target material to form macroparticles in said plasma to create a dusty plasma.

16. The method of claim 15, wherein a fusion reaction is caused by interactions of sub-atomic and atomic particles within said macroparticles of said dusty plasma.

17. The method of claim 16, wherein a plasma resonant cone is generated by propagation of said second electromagnetic wave in said plasma, wherein said plasma resonant cone facilitates the concentration of fusing particles to be in close proximity so as to make possible quantum tunneling through the coulombic barrier.

18. The method of claim 12, wherein the reactor chamber comprises at least one of stainless steel and titanium.

19. The method of claim 12, wherein the at least one reactant gas comprises at least one of the following: hydrogen, deuterium, tritium, boron trifluoride, and borane.

20. The method of claim 12, wherein the cylindrical reactor chamber further comprises an electron emitting material so as to reduce a coulombic barrier of a fusion reaction, wherein the electron emitting material is coupled to or coated on an inner surface of the reaction chamber, wherein the electron emitting material comprises at least one of the following: lanthanum hexaboride (LaB6), thoriated tungsten (W), and tantalum (Ta).

21. A method of fusion reaction, comprising:
ionizing a reactant gas in a uniform magnetic field by injecting into said gas an electromagnetic wave at an electron cyclotron resonance (ECR) frequency to form a plasma of ions and neutrals; and
exciting ions in said plasma by injecting into said plasma an electromagnetic wave at an ion cyclotron resonance frequency (ICR);
whereby particles in said plasma are caused to interact with a target material to cause a fusion reaction to occur.

22. The method of claim 21, wherein the ECR frequency is in a range of 2-560 GHz and the ICR frequency is in a range of 1-350 MHz.

23. The method of claim 21, wherein said particles in said plasma further interact with said target material to form macroparticles in said plasma to create a dusty plasma.

24. The method of claim 21, wherein a fusion reaction is caused by interactions of sub-atomic and atomic particles within said macroparticles of said dusty plasma.
